(19) United States
(12) Patent Application Publication
(10) Pub. No.: US 2019/0210053 A1
(43) Pub. Date: Jul. 11, 2019

(54) Vehicle Warming Device

(71) Applicant: NATIONAL TAIWAN UNIVERSITY, Taipei (TW)

(72) Inventors: Jung-Ho Cheng, Taipei City (TW); Ming-Yen Chen, New Taipei City (TW); Yu-Chin Chiang, Tainan City (TW)

(21) Appl. No.: 15/864,478

(22) Filed: Jan. 8, 2018

(51) Int. Cl. B05B 12/12; B60Q 9/00; B05B 1/02; B05B 9/03

(52) U.S. Cl. CPC B05B 12/122; B05B 9/03; B05B 1/02; B60Q 9/00

(57) ABSTRACT

A vehicle warning device is provided, which includes a detecting device, a processor and a plurality of spray devices. The detecting device detects an object near a vehicle and judging whether the object is a human body, if it is, the detecting device further detects the relative location between the human body and the vehicle and the distance between the human body and the vehicle. The processor further judges whether the relative location and the distance between the human body and the vehicle obstructs the passage that the vehicle can drive away, if it is, the processor transmits a start instruction to one of the spray devices corresponding to the human body to spray the stinky gas toward the human body to remind the human body to leave away from the periphery of the vehicle.

### FIELD OF THE INVENTION

The present invention relates to a warning device, particularly relates to a vehicle warning device, especially for when the a human body obstructs the passage that the vehicle cannot leave from the current location, the vehicle warning device used to remind the human body to leave away from the periphery of the vehicle to avoid traffic accident.

### BACKGROUND OF THE INVENTION

In order to improving the vehicle driving safety while driving, the BSM (blind spot monitoring) or BSD (blind spot detection) is arranged on sides of the vehicle to detect there is any other vehicle, object or human body near the vehicle, in which the sides of the vehicle means the front, the left, the right and/or the rear sides of the vehicle.

Although the vehicle driver can be reminded by above warning device such as BSM or BSD to avoid the vehicle accident. However, such warning device does not let the people who obstruct the passage when the vehicle leaving. In general, in order to remind the people who near the vehicle to leave, the vehicle driver usually gets off the vehicle to remind the people to leave or to generate the sound to warn. For example, the vehicle driver will press the horn to remind the people who obstruct the passage that the vehicle cannot drive away. However, the problem with the horn is not a good way to remind the people to leave if the sound is too loud or too sudden to scare the people.

### SUMMARY OF THE INVENTION

According to above drawbacks of the conventional prior art, an object of the present invention is to provide a warning device with a gentle warning to remind the people who obstruct the passage that the vehicle cannot drive away from the current location.

It is another object of the present invention to provide a vehicle warning device for detecting the human body who obstruct the passage that the vehicle cannot drive away from current location, and the warning device will spray the stinky gas to remind the people to leave away from the periphery of the vehicle, such that the vehicles can drive away to avoid the traffic accidents.

It is still an object of the present invention to provide a vehicle warning device to detect the relative location and the distance between the vehicle and human body who obstruct the passage that the vehicle cannot drive away from the current location, and also detect the wind condition for the vehicle at the current location, such that the intensity of the stinky gas and the spray direction can be adjusted at the same time.

According to above objects, the present invention provides a vehicle warning device, which includes a detecting device, a processor and a plurality of spray devices, in which the processor is electrically connected with the detecting device and the plurality of spray devices respectively. The detecting device is provided for judging whether an object near a vehicle and judging whether the object is a human body, if the object is human body, the detecting device further judges the relative location and the distance between the human body and the vehicle. The processor is provided for receiving the relative location and the distance between the human body and the vehicle, and the processor further judges whether the relative location and the distance between the human body and the vehicle obstructs the passage that the vehicle can or cannot leave from the current location. When the processor judges the relative location and the distance between the human body and the vehicle will obstruct the passage that the vehicle cannot leave away from the current location, the processor transmits a start instruction to one of the spray devices corresponding to the human body to spray the stinky gas toward the human body to remind the human body to leave away from the periphery of the vehicle.

In addition, the present invention further provides another vehicle warning device, which includes a detecting device, a wind detecting device, a processor and a plurality of spray device, and the processor is electrically connected with the detecting device, the wind detecting device and the plurality of spray devices respectively. The detecting device is provided for judging whether an object near a vehicle and judging whether the object is a human body, if the object is human object, the detecting device further judges the relative location and the distance between the human body and the vehicle.

In addition, the wind detecting device is provided for detecting a wind speed and a wind direction for the vehicle at a current location. The processor is provided for receiving the relative location and the distance between the human body and the vehicle, and the processor further judges whether the relative location and the distance between the human body and the vehicle obstructs the passage that the vehicle can or cannot leave from the current location. When the processor judges that the relative location and the distance between the human body and the vehicle obstruct the passage that the vehicle cannot leave from the current location, the processor transmits a start instruction to one of the spray devices corresponding to the relative location of the human body to spray the stinky gas toward the human body according to the wind speed and the wind direction of the relative location to remind the human body to leave away from the periphery of the vehicle.

### BRIEF DESCRIPTION OF THE DRAWINGS

FIG. 1 is a block diagram of showing one embodiment of a vehicle warning device in accordance with the present invention;

FIG. 2 is a flow chart of showing one embodiment of a vehicle warning device in accordance with the present invention;

FIG. 3 is a schematic of showing other vehicle or human body near the vehicle with the vehicle warning device in accordance with the present invention;

FIG. 4 is a schematic of showing another embodiment of the vehicle warning device in accordance with the present invention;

FIG. 5 is a flow chart of showing another embodiment of the vehicle warning device in accordance with the present invention; and

FIG. 6 to FIG. 13 are schematic diagrams of showing when the human body near the vehicle and in different positions, the vehicle warning device sprays the stinky gas according to the relative location and the distance between the human body and the vehicle in accordance with the present invention.

### DETAILED DESCRIPTION OF THE PREFERRED EMBODIMENT

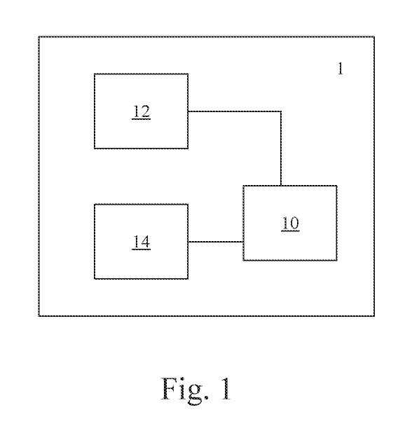

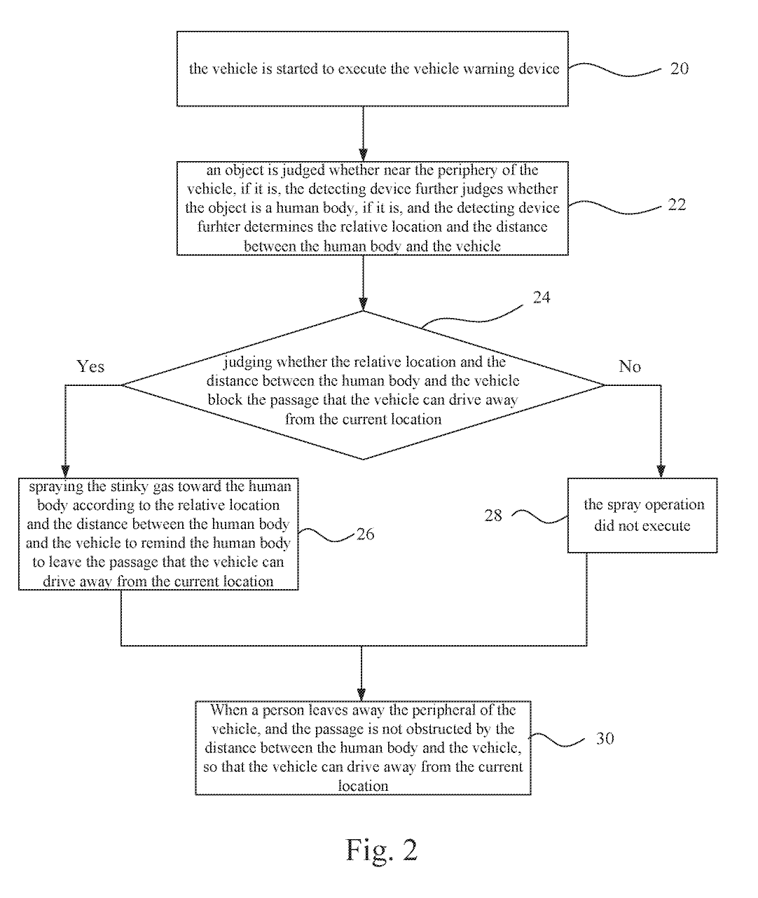

Please refer to FIG. 1 and FIG. 2. FIG. 1 is a block diagram of showing one embodiment of a vehicle warning device of the present invention. In FIG. 1, the vehicle warning device 1 at least includes a processor 10, a detecting device 12 and at least one spray device 14, in which the detecting device 12 is electrically connected with the spray device 14 and the processor 10 respectively.

Next, please refer to FIG. 2 and cooperate with FIG. 1. FIG. 2 is a flow chart of showing one embodiment of a vehicle warning device of the present invention. In FIG. 2, step 20, the vehicle is started to execute the vehicle warning device. In this step 20, the vehicle warning device 1 is to be started only after the vehicle is started, that is, the vehicle power supply system (not shown) must be turned on, and the vehicle warning device 1 is started when the vehicle warning device 1 is powered on. Thus, when the vehicle at flameout state, the vehicle warning device 1 did not perform any warning or detection operation. Next, step 22, an object is judged whether near the periphery of the vehicle, if it is, the detecting device further judges whether the object is a human body, if it is, and the detecting device further judges the relative location and the distance between the human body and the vehicle. In this step 22, the detecting device 12 is an image detecting device or an image capturing device. In addition to judging whether there is an object near the periphery of the vehicle, the detecting device 12 can also detect whether the object is a human body through the image detection. In addition, the detecting device 12 can detect the relative location and the distance between the human body and the vehicle by means of other non-contact detection, such as image detection, radar wave, laser and/or the like. In another embodiment of the present invention, when the detecting device 12 detects whether an object near the periphery of the vehicle, if it is, and the processor 10 will send a warning alarm to inform the vehicle driver. In this embodiment, the object can be a human body or a physical object.

Next, step 24, judging whether the relative location and the distance between the human body and the vehicle block the passage that the vehicle can drive away from the current location, if it is, go to step 26, otherwise, go to step 28. In step 24, the detecting device 12 transmits the data of the relative location and the distance between the human body and the vehicle that is detected at step 22. Then, the processor 10 judges whether the relative location and the distance between the human body and the vehicle obstruct the passage that the vehicle can drive away from the current location. In general, the distance between the human body and the vehicle keeps larger than 100 cm. In this embodiment of the present invention, the distance between the human body and the vehicle obstructed the passage that the vehicle can drive away is at least greater than the range of about 100 cm-150 cm, the second smaller distance is in the range of about 60 cm-90 cm, and the minimum distance is in the range of about 30 cm-50 cm. Thus, taking the minimum distance of 30 cm-50 cm as an example, when the detecting device 12 detects the distance between the human body and the vehicle is in the range of about 30 cm-50 cm, the processor 10 judges that the human body has obstructed the passage which the vehicle can drive away from the current location. In addition, it should be explained that when the detecting device 12 detects that there is not only one human bodies near the periphery of the vehicle, as long as the one human body and the distance between the vehicles is within 30 cm-50 cm, the processor 10 will judge that the human body has obstructed the passage that the vehicle can drive away from the current location.

Next, in step 26, spraying the stinky gas toward the human body according to the relative location and the distance between the human body and the vehicle to remind the human body to leave the passage that the vehicle can drive away from the current location. In step 26, since the foregoing step 24 judges that the relative location and the distance between the human body and the vehicle has obstructed the passage that the vehicle can drive away from the current location, the processor 10 transmits a start instruction to the spray device 14 to sprays the stinky gas toward the human body who obstructed the passage that the vehicle can drive away to remind the human to leave away the periphery of the vehicle. In this embodiment of the present invention, the spray device 14 can arrange at the front side of the vehicle, the back side of the vehicle, the left side of the vehicle, the right side of the vehicle, the left head light of the vehicle, the right head light of the vehicle, the left tail light of the vehicle, and/or the right tail light of the vehicle. Each spray device 14 includes at least one nozzle (not shown in Figure) and a container (not shown in Figure), and the container used to accommodate the liquid, in which the liquid is volatile and generate stinky smell, such as ammonia water or urine-containing water. Such liquid is volatile, environmentally friendly and does not harm the human body.

For example, the diameter of the nozzle ranges from 2 mm to 2.5 mm, the cross-sectional area of the nozzle ranges from 4 mm² to 4.5 mm², the spray covering area ranges from 3200 mm² to 3500 mm². Therefore, it can be obtained that the spray covering area divided by the cross-sectional area of the nozzle is in the ranges from the 777.8 m-800 m, and the sniff value ranges from 1.5 ppm-1.6 ppm. Therefore, the liquid concentration in the container of the spray device 14 ranges from 1166.7 ppm-1280 ppm that is calculated from the sniff value (1.5 ppm-1.6 ppm) multiplied by the 777.8 m-800 m. Therefore, the person who stands greater than 1 meter that still can smell stinky gas from the nozzle of the spray device 14.

Subsequent to step 26, at step 30, after the person left the periphery of the vehicle, and the distance between the human body (or person) and the vehicle would not obstructed the passage where the vehicle can leave away from the current location. In this step, most people, when they smell unpleasant odors, such as ammonia or urine, will immediately leave the current location and move to a place without the smell or at least leaves away from the area where the smell is. As a result, the objective by using a gentle manner to remind the people who near the periphery of the vehicle to leave away that can be achieved.

In addition, when the forgoing step 24 judges the relative location and the distance between the human body and the vehicle will not be obstructed the passage that the vehicle can drive away from the current location, then go to step 28. The step 28, the spray operation did not execute. In step 24, since the processor 10 judges that the distance between the human body and the vehicle is greater than the preset safety distance of the vehicle warning device 1, for example, the safety distance is 100 cm or larger, the processor 10 can judge that the distance between the human body and the vehicle can let the vehicle drive away from the current location (such as parking space or passage), and will not hit the person (or human body). Accordingly, the spray device 14 is not executed to spray the stinky gas (step 28). Therefore, following step 28, in step 30, when a person leaves the periphery of the vehicle, and the passage is not obstructed by the distance between the human body and the vehicle, so that the vehicle can drive away from the current location.

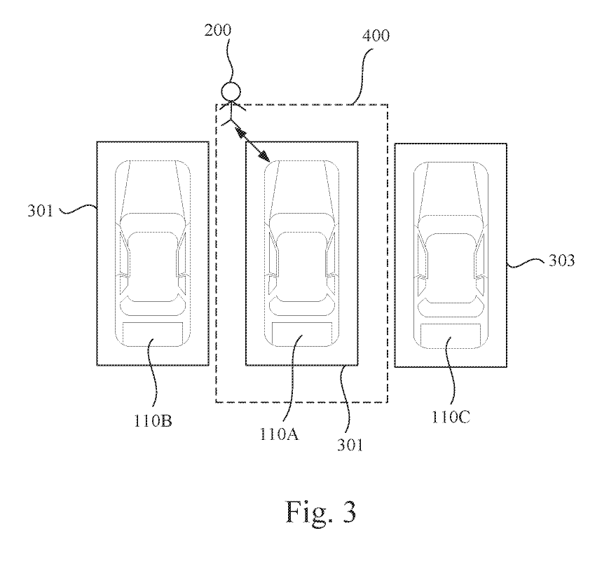

Please refer to FIG. 3. FIG. 3 is a schematic of showing one embodiment of other vehicle or human body near the periphery of the vehicle with the vehicle warning device of the present invention. While illustrating FIG. 3, please also cooperate with FIG. 1 and FIG. 2 at the same time. It is firstly to be illustrated that the reference numbers 301-303 indicate parking spaces respectively, and the reference number 400 indicates the preset safety distance of the vehicle warning device 1. When the driver launches the vehicle 110A, the vehicle warning device 1 is also activated at the same time. At this time, the detecting device 12 of the vehicle warning device 1 judges whether there is an object adjacent to the periphery of the vehicle 110A. According to the result of the above detection, it is found that the left side, the right side and the left head light of the vehicle 110A have the objects 110B, 110C, and 200, respectively. The detecting device 12 further judges the objects 110B, 110C and 200 to obtain only object 200 at the left head light of the vehicle 110A is a human body. Next, the detecting device 12 further judges the distance and the relative location between the human body 200 and the vehicle 110A whether is in a preset safety distance. In FIG. 3, the area 400 indicated by the dotted line is a preset safety distance. The preset safety distance of the vehicle warning device 1 of the present invention is 150 cm. Thus, the distance of the vehicle warning device 1 of the present invention is 85 cm (the distance indicated by the double arrow as shown in FIG. 3), and the relative location between the human body 200 and the vehicle is in the 10-11 o'clock direction of the clock. Accordingly, the processor 10 confirms that the human body 200 has obstructed the passage that the vehicle 110A can drive away from the current location. Next, the processor 10 transmits a start instruction to the spray device 14 arranged on the left head light of the vehicle 110A to spray the stinky gas toward the human body 200. By using the liquid that is volatile, environmentally friendly and does not harm the human body (people 200) to remind the person to leave away from the vehicle 110A, and the vehicle 110A can drive away from the current location (the parking space 302). Such reminders or warning manner compared to the horn to remind the person who obstructs the passage for the vehicle is more modest, and the person would not be scared suddenly by the sound of the vehicle horn, so as to the unnecessary conflicts can be avoided.

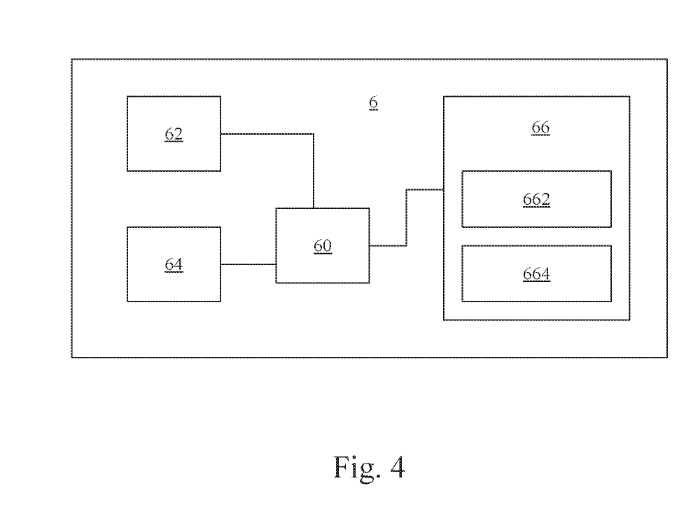

Next, please refer to FIG. 4. FIG. 4 is a schematic of showing another embodiment of the vehicle warning device of the present invention. In FIG. 4, the vehicle warning device 6 includes a processor 60, a detecting device 62, at least one spray device 64 and a wind detecting device 66, in which the processor 60 is electrically connected with the detecting device 62, the spray device 64, and the wind detecting device 66 respectively. In this embodiment, the processor 60, the function and the purpose for the detecting device 62, and the spray device 64 are the same as that of the processor 10, the detecting device 12, and the spray device 14 in forgoing FIG. 1, and thus it is not described repeatedly herein. It should be noted that, in the embodiment of the present invention, in order to enable the person adjacent the periphery of the vehicle to smell the stinky gas that is sprayed by the spray device 64, the vehicle warning device 6 further includes a wind detecting device 66. By detecting wind conditions at the current environment where the vehicle is located, the spray device 64 relative to the human body who nearby the vehicle is turned on, so that the stinky gas sprayed by the spray device 64 can quickly diffuse in the air toward the human body who nearby the vehicle, such that the person would smell the stinky gas to leave the periphery of the vehicle.

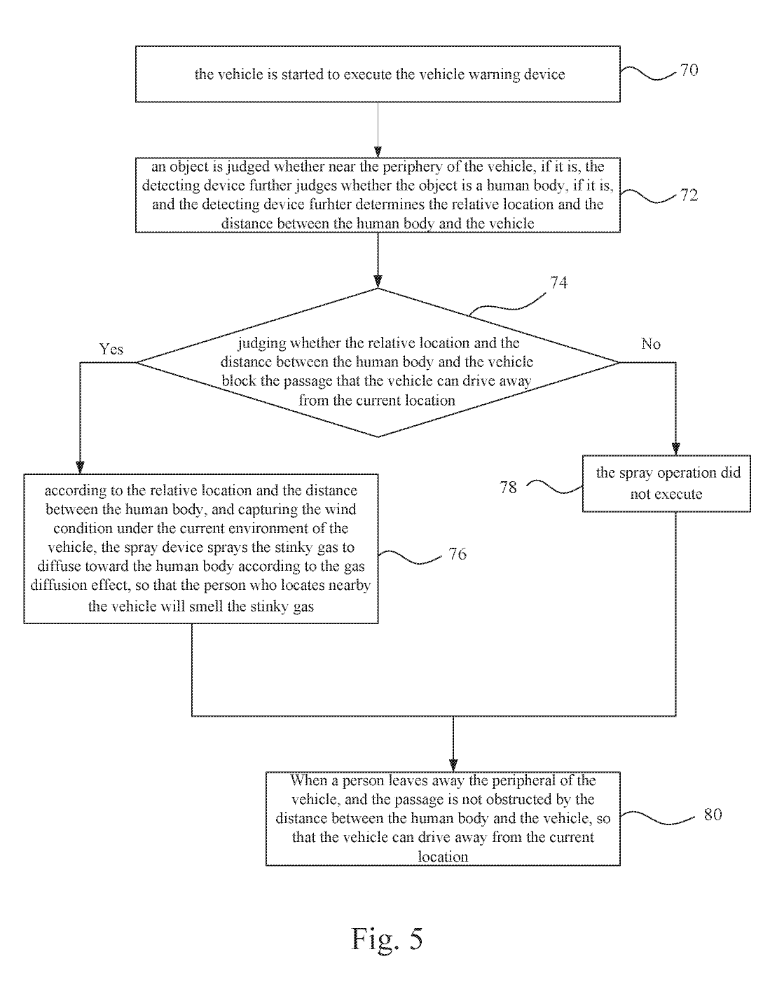

Please refer to FIG. 5. FIG. 5 is a flow chart of showing another embodiment of the vehicle warning device of the present invention. Step 70 to Step 74 is the same as the forging step 20 to step 24 (as shown in FIG. 2), it is not to be described herein. The different between FIG. 5 and the forging FIG. 2 is that, step 76, according to the relative location and the distance between the human body, and capturing the wind condition under the current environment of the vehicle, the spray device sprays the stinky gas to diffuse toward the human body according to the gas diffusion effect, so that the person who locates nearby the vehicle will smell the stinky gas. In the forgoing step 74, the relative location and the distance between the human body and the vehicle has obstructed the passage which the vehicle can drive away from the current location. Accordingly, in this step 76, the processor 70 transmits a start instruction to the spray device 74 to spray the stinky gas, and the stinky gas is diffused by the wind in the air toward the person who locates nearby the vehicle to remind the person to leave away from the periphery of the vehicle. As shown in forgoing FIG. 2, after step 76, in step 80, when the person leaves away the periphery of the vehicle and the distance between the human body and the vehicle would not obstruct the passage, the vehicle can drive away from the current location.

Furthermore, when the step 74 judges whether the distance and the relative location between the human body and the vehicle is not obstructed by the person, and next go to step 78, the spray operation did not execute. Furthermore, please continue with step 80. When a person leaves the peripheral of the vehicle, and the passage is not obstructed by the distance between the human body and the vehicle, so that the vehicle can drive away from the current location.

In this embodiment of the present invention, the wind detecting device 66 detects the wind direction, the wind strength, and the wind speed for the vehicle under the current environment by using Beaufort wind force scale. The Beaufort wind force scale as shown in Table 1:

TABLE 1

| | International Standard (published by WMO) | | | | | Effects Observed Far From Land | | | |
|---|---|---|---|---|---|---|---|---|---|
| Beaufort | | Speed | | | | | normal | maximum | |
| number | Name | m/s | Km/h | knot | mph | Name | m | | Effect Observed On the Land |
| 0 | calm | 0-0.2 | <1 | <1 | <1 | NA | NA | NA | Sea like mirror |
| 1 | Light air | 0.3-1.5 | 1-5 | 1-3 | 1-3 | Light | 0.1 | 0.1 | Rippies with appearances |
| | | | | | | waves | | | of scales; no foam crests |
| 2 | Light | 1.6-3.3 | 6-11 | 4-6 | 4-7 | | 0.2 | 0.3 | Small wavelets; cresrs |
| | breeze | | | | | | | | of glassy appearance, |
| | | | | | | | | | not breaking; |
| 3 | Gentle | 3.4-5.4 | 12-19 | 7-10 | 8-12 | Little | 0.6 | 1.0 | Large wavelets; crests |
| | breeze | | | | | waves | | | begin to break; |
| | | | | | | | | | scattered whitecaps |
| 4 | Moderate | 5.5-7.9 | 20-28 | 11-16 | 13-18 | Small | 1.0 | 1.5 | Small waves, becoming |
| | breeze | | | | | waves | | | longer; numerous |
| | | | | | | | | | whitecaps |
| 5 | Fresh | 8.0-10.7 | 29-38 | 17-21 | 19-24 | Moderate | 2.0 | 2.5 | Moderate waves, taking |
| | breeze | | | | | waves | | | longer form; many |
| | | | | | | | | | whitecaps; some spray |
| 6 | Strong | 10.8-13.8 | 39-49 | 22-27 | 25-31 | Big | 3.0 | 4.0 | Larger waves forming; |
| | breeze | | | | | waves | | | whitecaps everywhere; |
| | | | | | | | | | more spray |
| 7 | Near | 13.9-17.1 | 50-61 | 28-33 | 32-38 | | 40 | 5.5 | Sea heaps up; white |
| | gale | | | | | | | | foam from breaking waves |
| | | | | | | | | | begins to be flown in |
| | | | | | | | | | streaks |

Accordingly, when the detecting device 62 detects a human body that located nearby the vehicle and the human body has obstructed the passage that the vehicle cannot drive away, the wind detecting device 66 also captures the wind condition under current environment, so that the spray device 64 can determine the current wind speed by the wind speed detecting unit 662 of the wind detecting device 66, and the current wind direction by the wind direction detecting unit 664. The processor 66 can adjust the flow rate of the stinky gas that is sprayed from the spray device 64, such that the flow rate of the stinky gas sprayed out of the vehicle is enough to diffuse in the air by current wind speed and wind direction toward the person, so as to the person who obstructs the passage can smell the stinky gas. For example, when the wind strength detected by the wind detecting device 66 is 2 (according to the Beaufort number of the Beaufort wind force scale), the wind speed is 1.6-3.3 m/s, the flow rate of stinky gas sprayed from the spray device 64 can be increased, such that the more stinky gas is sprayed out. Therefore, the person who obstructed the passage to let the vehicle cannot drive away from the current location can quickly and easily smell the stinky gas to leave away from the periphery of the vehicle. In another embodiment, when the wind strength detected by the wind detecting device 64 is 5 and the wind speed is 8.0-10.7 m/s, the flow rate of the stinky gas can be reduced or not adjusted. At this time, the stinky gas is diffused in the air toward the person by the current wind speed and the current wind strength of the external environment. By external wind speed and wind strength to diffuse the stinky gas toward the person, the gas diffusion effect allowed the person to smell the stinky gas so that the person could leave away from the periphery of the vehicle after smelling the stinky gas, and the purpose of the vehicle could drive away from the current location that can be achieved.

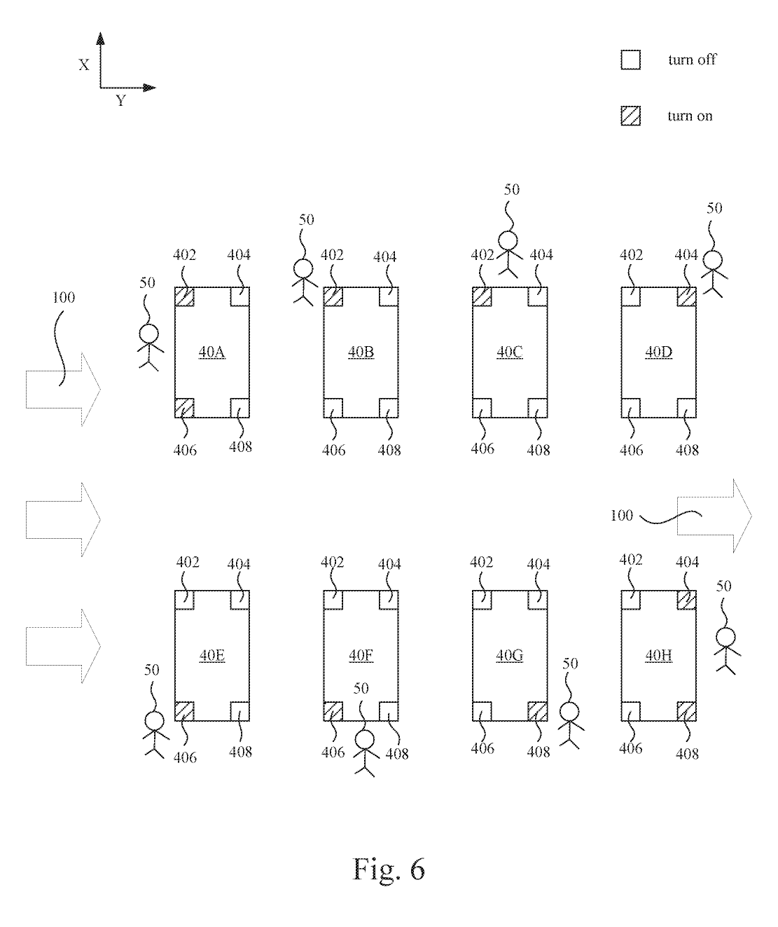

Please refer to FIG. 6 to FIG. 13. FIG. 6 to FIG. 13 are schematic diagrams of showing when the human body near the vehicle and in different positions, the vehicle warning device sprays the stinky gas according to the relative location and the distance between the human body and the vehicle. First, in FIG. 6 to FIG. 13, the reference numbers 40A-40H indicate the vehicles, the reference numbers 402-408 indicate the spray devices. The spray devices 402-408 can be arranged at the left head light of the vehicle, the right head light of the vehicle, the left tail light of the vehicle, and right tail light of the vehicle respectively. It should be explained is that the spray devices 402-408 can arrange at the left head light, the right head light, the left tail light, the right tail light, or adjacent at the left head light, the right head light, the left tail light, the right tail light, the arrangement of spray devices 402-408 is not to limit herein. In addition, the X-Y coordinate used to show the directions for the front side and the rear side of the vehicle for convenience of illustration of the embodiments of the present invention. Thus, in X direction, toward the top of the drawing indicates the front side of the vehicle, the bottom of the drawing indicates the rear side of the vehicle.

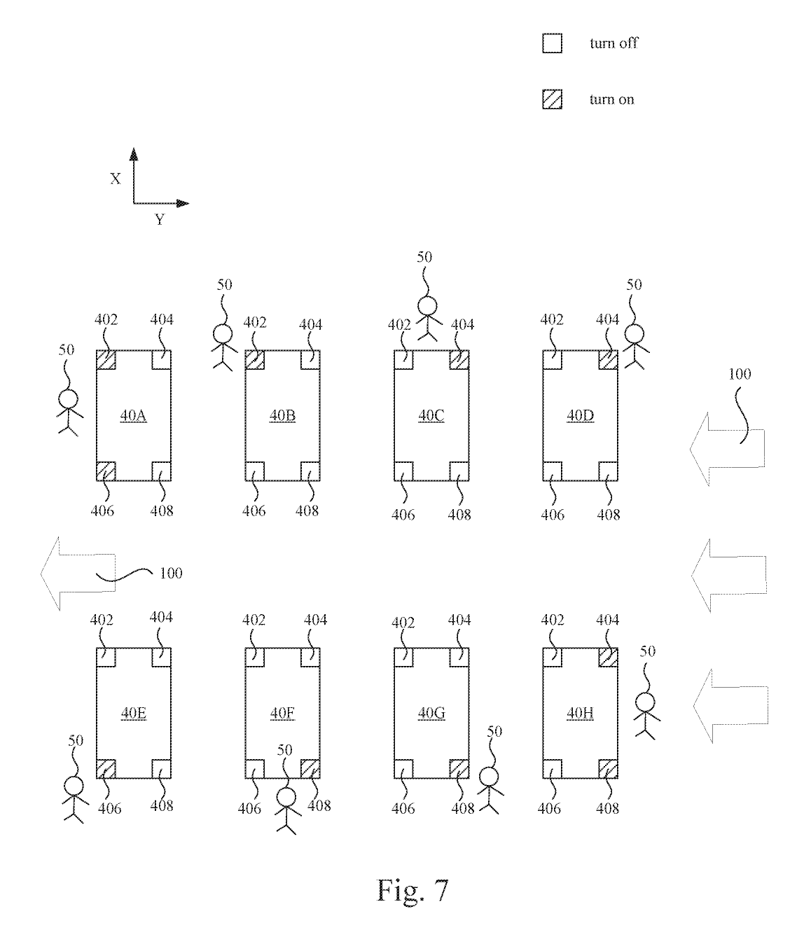

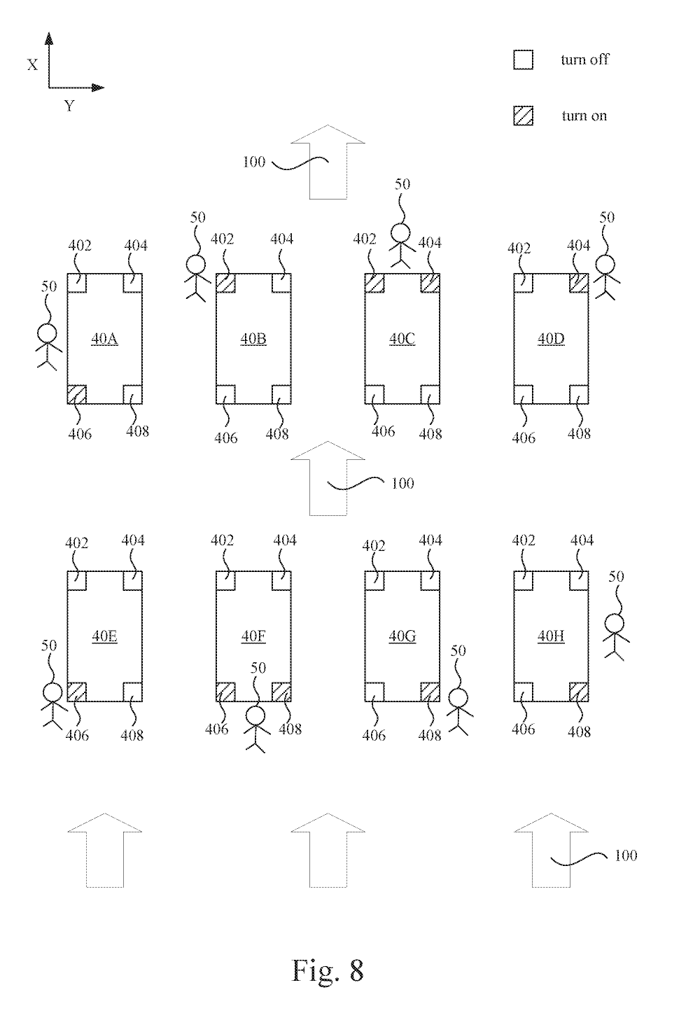

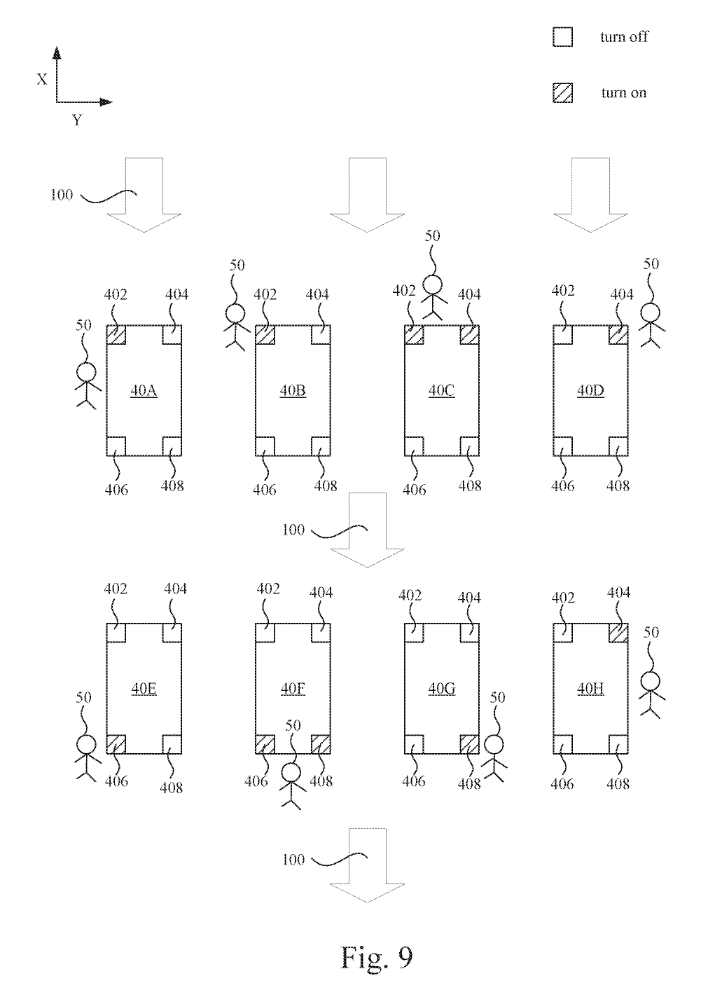

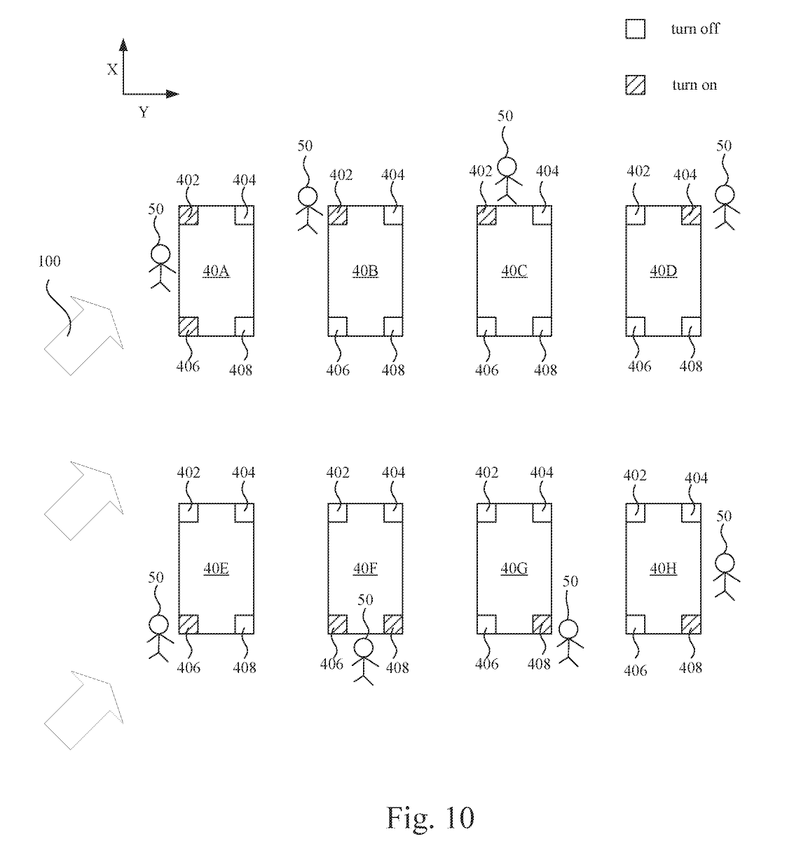

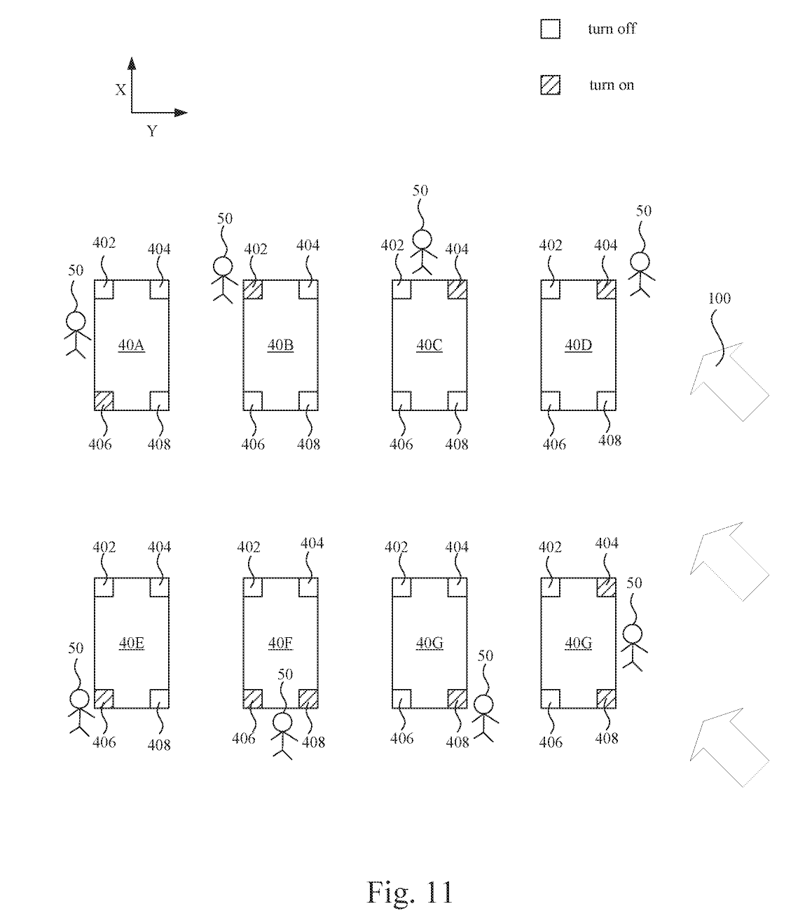

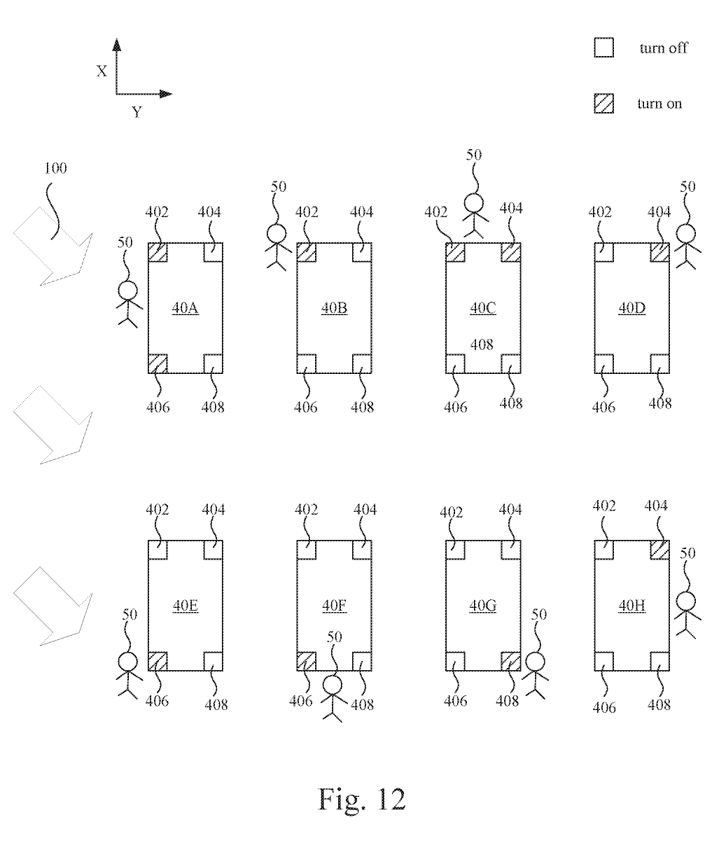

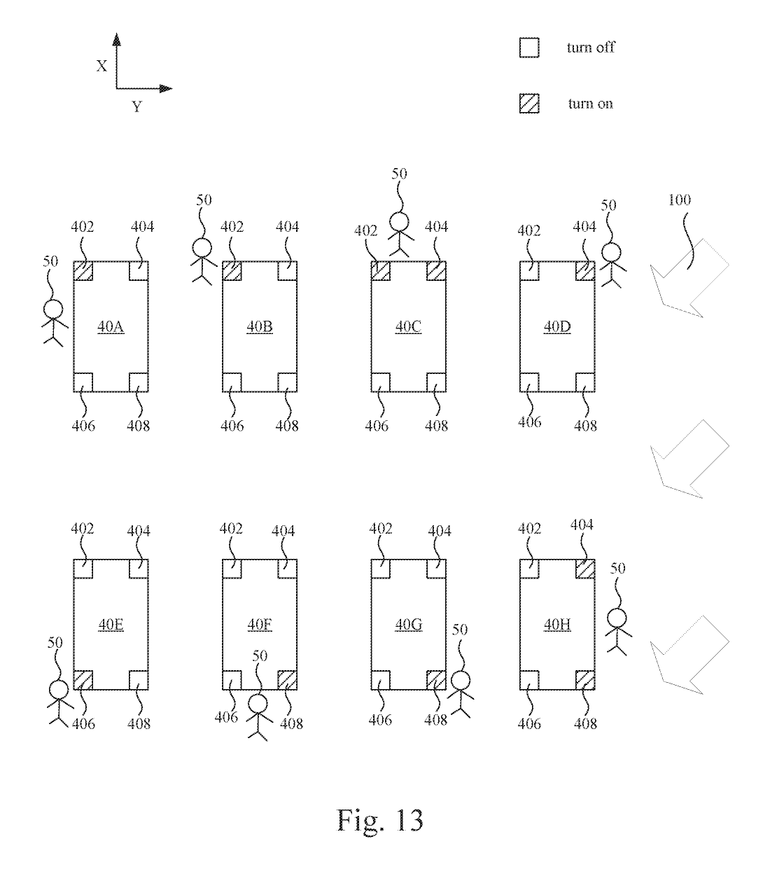

Moreover, the direction of the arrow 100 in FIG. 6 to FIG. 13 indicates the direction of the wind. As shown in FIG. 6 to FIG. 13, the left side of the drawing is the west, the right side of the drawing is the east, the top side of the drawing is north, and the bottom side of the drawing is the south. Thus, the directions of arrows 100 in FIG. 6 to FIG. 13 are respectively: the arrow 100 in FIG. 6 indicates the west wind, the arrow 100 in FIG. 7 indicates the east wind, the arrow 100 in FIG. 8 indicates the south wind, the arrow 100 in FIG. 9 indicates the north wind, the arrow 100 in FIG. 10 indicates the southwest wind, the arrow 100 in FIG. 11 indicates southwest wind, the arrow 100 in FIG. 12 indicates the northwest wind, and the arrow 100 in FIG. 13 indicates the northeast wind. In addition, In addition, in FIGS. 6-13, a blank grid shows the turn-off status for the spray devices 402-408, and a diagonal grid shows the turn-on status for spray devices 402-408.

Please refer to FIG. 6, and cooperate with FIG. 4 and FIG. 5. In FIG. 6, taking the vehicle 40D as the example, when the detecting device 62 detects an object 50 nearby the vehicle 40D, according to the flow chart of forgoing FIG. 5, the detecting device 62 will detect and judge whether the object 50 is physical object or a human body, if the object 50 is human body, the detecting device 62 further detects the distance and the relative location between the human body 50 and the vehicle 40D, and the wind detecting device 66 captures the wind condition at the current environment for the vehicle 40D. Herein, the detecting and determining steps for the detecting device 62 and the detecting step for the wind detecting device 66 are the same as forgoing described and it is not described repeatedly. When the detecting device 62 detects the human body 50 nearby the vehicle 40D, the detecting device 62 judges that the position of the human body 50 with respect to the vehicle 40D is at 1-2 o'clock direction of the clock, that is, the position of the human body 50 is near in front of the right head light of the vehicle 40D. At this time, the processor 60 of the vehicle warning device 6 transmits a start instruction to the spray device 404 arranged at the right head light of the vehicle 40D to spray the stinky gas. Since the direction of the wind is the westerly wind, it is blown from the left side of the drawing of FIG. 6 toward the right side of the drawing, when the spray device 404 sprays the stinky gas, the person (human body 50) will smell the stinky gas according to the gas diffusion effect. Because the stinky gas is pungent (such as urine or ammonia-containing water), the person (human body 50) will immediately leave away from the place where the stinky gas is existed. Therefore, after the person (human body 50) left away from the periphery of the vehicle 40D, so that the vehicle 40D can drive away from the current location.

In another embodiment, when the detecting device 62 judges the position for the person (human body 50) is at the right tail light of the vehicle 40G (also see in FIG. 6) and the position is at a 4-5 o'clock direction of the clock, the processor 60 transmits the start instruction to the spray device 408 arranged at the right tail light of the vehicle 40G to spray the stinky gas. Similarly, since the direction of the wind is the west wind, it is blown from the left side of the drawing of FIG. 6 toward the right side of the drawing, when the spray device 408 sprays the stinky gas, the person (human body 50) who locates nearby the vehicle 40G will smell the stinky gas according to the gas diffusion effect. Similarly, the stinky gas is pungent (such as ammonia water or urine-containing water), the person (human body 50) will immediately leave away from the place where the stinky gas is existed. Therefore, after the person (human body 50) left away from the periphery of the vehicle 40G, so that the vehicle 40G can drive away from the current location.

Furthermore, taking the vehicle 40C in FIG. 7 as an example, the wind direction in FIG. 7 is east wind. When the detecting device 62 judges that the position of the person (human body 50) with respect to the vehicle 40C is at 12 o'clock direction of the clock, that is, the position of the person (human body 50) is near in front side of the vehicle 40C. At this time, the processor 60 of the vehicle warning device 6 transmits a start instruction to the spray device 404 arranged at the right head light of the vehicle 40C to spray the stinky gas. Since the direction of the wind is the east wind, it is blown from the right side of the drawing of FIG. 6 toward the left side of the drawing, when the spray device 404 sprays the stinky gas, the person (human body 50) will smell the stinky gas according to the gas diffusion effect. Because the stinky gas is pungent (such as ammonia water or urine-containing water), the person (human body 50) will immediately leave away from the place where the stinky gas is existed. Therefore, after the person (human body 50) left away from the periphery of the vehicle 40C, so that the vehicle 40C can drive away from the current location.

Continuously, taking the vehicle 40H in FIG. 8 as an example, the wind direction in FIG. 8 is south wind. When the detecting device 62 judges that the position of the person (human body 50) with respect to the vehicle 40H is at 3 o'clock direction of the clock, that is, the position of the person (human body 50) is near in right side of the vehicle 40H. At this time, the processor 60 of the vehicle warning device 6 transmits a start instruction to the spray device 408 arranged at the right tail light of the vehicle 40H to spray the stinky gas. Since the direction of the wind is the south wind, it is blown from the bottom side of the drawing of FIG. 8 toward the top side of the drawing, when the spray device 408 sprays the stinky gas, the person (human body 50) will smell the stinky gas according to the gas diffusion effect. Because the stinky gas is pungent (such as ammonia water or urine-containing water), the person (human body 50) will immediately leave away from the place where the stinky gas is existed. Therefore, after the person (human body 50) left away from the periphery of the vehicle 40H, so that the vehicle 40H can drive away from the current location.

FIG. 9 shows another embodiment of the present invention, taking the vehicle 40F in FIG. 9 as an example, the wind direction in FIG. 9 is north wind. When the detecting device 62 judges that the position of the person (human body 50) with respect to the vehicle 40F is at 6 o'clock direction of the clock, that is, the position of the person (human body 50) is near the rear side of the vehicle 40F. At this time, the processor 60 of the vehicle warning device 6 transmits a start instruction to the spray devices 406, 408 arranged at the right tail light and the left tail light of the vehicle 40F respectively to spray the stinky gas. Since the direction of the wind is the north wind, it is blown from the top side of the drawing of FIG. 6 toward the bottom side of the drawing, when the spray devices 406, 408 respectively sprays the stinky gas, the person (human body 50) will smell the stinky gas according to the gas diffusion effect. Because the stinky gas is pungent (such as ammonia water or urine-containing water), the person (human body 50) will immediately leave away from the place where the stinky gas is existed. Therefore, after the person (human body 50) left away from the periphery of the vehicle 40F, so that the vehicle 40F can drive away from the current location.

FIG. 10 shows another embodiment of the present invention, taking the vehicle 40E in FIG. 10 as an example, the wind direction in FIG. 10 is southwest wind. When the detecting device 62 judges that the position of the person (human body 50) with respect to the vehicle 40E is at 7-8 o'clock direction of the clock, that is, the position of the person (human body 50) is near the left tail light of the vehicle 40E. At this time, the processor 60 of the vehicle warning device 6 transmits a start instruction to the spray device 406 arranged at the left tail light of the vehicle 40E to spray the stinky gas. Since the direction of the wind is the southwest wind, it is blown from the bottom left side of the drawing of FIG. 6 toward the top right side of the drawing, when the spray device 406 respectively sprays the stinky gas, the person (human body 50) will smell the stinky gas according to the gas diffusion effect. Because the stinky gas is pungent (such as ammonia water or urine-containing water), the person (human body 50) will immediately leave away from the place where the stinky gas is existed. Therefore, after the person (human body 50) left away from the periphery of the vehicle 40E, so that the vehicle 40E can drive away from the current location.

FIG. 11 shows one embodiment of the present invention, taking the vehicle 40B in FIG. 11 as an example, the wind direction in FIG. 11 is southeast wind. When the detecting device 62 judges that the position of the person (human body 50) with respect to the vehicle 40B is at 10-11 o'clock direction of the clock, that is, the position of the person (human body 50) is near the left head light of the vehicle 40B. At this time, the processor 60 of the vehicle warning device 6 transmits a start instruction to the spray device 402 arranged at the left head light of the vehicle 40B to spray the stinky gas. Since the direction of the wind is the southeast wind, it is blown from the bottom right side of the drawing of FIG. 6 toward the top left side of the drawing, when the spray device 402 respectively sprays the stinky gas, the person (human body 50) will smell the stinky gas according to the gas diffusion effect. Because the stinky gas is pungent (such as ammonia water or urine-containing water), the person (human body 50) will immediately leave away from the place where the stinky gas is existed. Therefore, after the person (human body 50) left away from the periphery of the vehicle 40B, so that the vehicle 40B can drive away from the current location.

FIG. 12 shows one embodiment of the present invention, taking the vehicle 40H in FIG. 12 as an example, the wind direction in FIG. 12 is northwest wind. When the detecting device 62 judges that the position of the person (human body 50) with respect to the vehicle 40H is at 3 o'clock direction of the clock, that is, the position of the person (human body 50) is near the right side of the vehicle 40H. At this time, the processor 60 of the vehicle warning device 6 transmits a start instruction to the spray device 404 arranged at the right head light of the vehicle 40H to spray the stinky gas. Since the direction of the wind is the southeast wind, it is blown from the top left side of the drawing of FIG. 6 toward the bottom right side of the drawing, when the spray device 404 respectively sprays the stinky gas, the person (human body 50) will smell the stinky gas according to the gas diffusion effect. Because the stinky gas is pungent (such as ammonia water or urine-containing water), the person (human body 50) will immediately leave away from the place where the stinky gas is existed. Therefore, after the person (human body 50) left away from the periphery of the vehicle 40H, so that the vehicle 40H can drive away from the current location.

FIG. 13 shows one embodiment of the present invention, taking the vehicle 40F in FIG. 13 as an example, the wind direction in FIG. 13 is northeast wind. When the detecting device 62 judges that the position of the person (human body 50) with respect to the vehicle 40F is at 6 o'clock direction of the clock, that is, the position of the person (human body 50) is near the rear side of the vehicle 40F. At this time, the processor 60 of the vehicle warning device 6 transmits a start instruction to the spray device 408 arranged at the right tail light of the vehicle 40F to spray the stinky gas. Since the direction of the wind is the northwest wind, it is blown from the top right side of the drawing of FIG. 13 toward the bottom left side of the drawing, when the spray device 404 respectively sprays the stinky gas, the person (human body 50) will smell the stinky gas according to the gas diffusion effect. Because the stinky gas is pungent (such as ammonia water or urine-containing water), the person (human body 50) will immediately leave away from the place where the stinky gas is existed. Therefore, after the person (human body 50) left away from the periphery of the vehicle 40F, so that the vehicle 40F can drive away from the current location.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A vehicle warning device, comprising:
a detecting device is provided for judging whether an object near a vehicle and judging whether the object is a human body, if the object is the human body, the detecting device further detects the relative location and the distance between the human body and the vehicle;
a processor is provided for electrically connecting with the detecting device and is provided for receiving the relative location and the distance between the human body and the vehicle, and the processor further judges whether the relative location and the distance between the human body and the distance obstructs the passage that the vehicle can drive away; and
a plurality of spray devices is provided for electrically connecting with the processor, when the processor judges the relative location and the distance between the human body and the vehicle will obstruct the passage that the vehicle can drive away, the processor transmits a start instruction to one of the spray devices corresponding to the human body to spray the stinky gas toward the human body to remind the human body to leave away from the periphery of the vehicle.

2. The vehicle warning device according to claim 1, wherein the relative location and the distance between the human body and the vehicle obstructed the passage that the vehicle can drive away is less than 100 cm.

3. The vehicle warning device according to claim 1, wherein the relative location between the human body and the vehicle is near a right side of the vehicle, a left side of the vehicle, a right head light of the vehicle, a left head light of the vehicle, a right tail light of the vehicle, a left tail light of the vehicle, a front side of the vehicle or a rear side of the vehicle.

4. The vehicle warning device according to claim 1, wherein each the plurality of spray devices includes at least one nozzle and a container.

5. The vehicle warning device according to claim 1, wherein each the plurality of spray devices includes a liquid therein, wherein the liquid is pungent, volatile, environmentally friendly and does not harm the human body.

6. The vehicle warning device according to claim 5, wherein the liquid is ammonia water or urine-containing water.

7. The vehicle warning device according to claim 1, wherein each of the plurality of spray devices is arranged at a front side of the vehicle, a rear side of the vehicle, a left side of the vehicle, a right side of the vehicle, a left head light of the vehicle, a right head light of the vehicle, a right tail light of the vehicle and/or a left tail light of the vehicle.

8. The vehicle warning device according to claim 1, further comprising the detecting device judges whether the object locates near the periphery of the vehicle, if it is, the processor also transmits a warning alarm to inform a vehicle driver.

9. A vehicle warning device, comprising:
a detecting device is provided for judging whether an object locates near a vehicle and judging whether the object is a human body, if the object is the human body, the detecting device further detects the relative location and the distance between the human body and the vehicle;
a wind detecting device is provided for detecting a wind speed and a wind direction of the vehicle at a current location;
a processor is provided for electrically connecting with the detecting device and the wind detecting device respectively, and is provided for receiving the relative location and the distance between the human body and the vehicle, and the processor further judges whether the relative location and the distance between the human body and the vehicle obstructs the passage that the vehicle can drive away; and
a plurality of spray devices is provided for electrically connecting with the processor, when the processor judges the relative location and distance between the human body and the vehicle will obstruct the passage that the vehicle can drive away, the processor transmits a start instruction to one of the spray devices corresponding to the relative location of the human body to spray the stinky gas toward the human body according to the wind speed and the wind direction of the relative location to remind the human body to leave away from the periphery of the vehicle.

10. The vehicle warning device according to claim 9, wherein the relative location and the distance between the human body and the vehicle obstructed the passage that the vehicle can drive away is less than 100 cm.

11. The vehicle warning device according to claim 9, wherein the relative location between the human body and the vehicle is near a right side of the vehicle, a left side of the vehicle, a right head light of the vehicle, a left head light of the vehicle, a right tail light of the vehicle, a left tail light of the vehicle, a front side of the vehicle or a rear side of the vehicle.

12. The warning device for vehicle according to claim 9, wherein each of the plurality of spray devices includes at least one nozzle and a container.

13. The vehicle warning device according to claim 9, wherein each of the plurality of spray devices includes a liquid therein, wherein the liquid is volatile, environmentally friendly and does not harm the human body.

14. The vehicle warning device according to claim 13, wherein the liquid is ammonia water or urine-containing water.

15. The vehicle warning device according to claim 9, wherein each of the plurality of spray devices is arranged at a front side of the vehicle, a rear side of the vehicle, a left side of the vehicle, a right side of the vehicle, a left head light of the vehicle, a right head light of the vehicle, a right tail light of the vehicle and/or a left tail light of the vehicle.

16. The vehicle warning device according to claim 9, further comprising the detecting device determines whether the object is located near the vehicle, if it is, the processor also sends a warning alarm to inform a vehicle driver.
